(19) United States
(12) Patent Application Publication
(10) Pub. No.: US 2025/0021645 A1
(43) Pub. Date: Jan. 16, 2025

(54) Context-Based Countermeasures for Cybersecurity Threats

(71) Applicant: CSP Inc., Lowell, MA (US)

(72) Inventors: Henry Tumblin, Castine, ME (US); Gary Southwell, Leander, TX (US)

(21) Appl. No.: 18/771,395

(22) Filed: Jul. 12, 2024

Related U.S. Application Data
(60) Provisional application No. 63/526,654, filed on Jul. 13, 2023.
(60) Provisional application No. 63/670,112, filed on Jul. 11, 2024.

(51) Int. Cl. G06F 21/55

(52) U.S. Cl. CPC G06F 21/554; G06F 2221/034

(57) ABSTRACT

The various implementations described herein include methods and devices for deploying context-based countermeasures against cybersecurity threats. In one aspect, a method includes identifying a process running on the computing device, and in response to identifying the process running on the computing device: (i) selecting one or more countermeasures from a plurality of countermeasures based at least in part on the determined process and (ii) executing each of the selected countermeasures at the computing device. In another aspect, a method includes determining an operating context for the computing device, identifying a set of one or more countermeasures from a plurality of countermeasures based on the determined operating context, and deploying the set of one or more countermeasures at the computing device.

### RELATED APPLICATIONS

This application claims priority to U.S. Provisional Application Ser. No. 63/526,654, filed Jul. 13, 2023, titled “Context-based Countermeasures for Cybersecurity Threats,” which is incorporated by reference herein in its entirety.

This application claims priority to U.S. Provisional Application Ser. No. 63/670,112, filed Jul. 11, 2024, titled “Context-based Countermeasures for Cybersecurity Threats,” which is incorporated by reference herein in its entirety.

### TECHNICAL FIELD

The disclosed implementations relate generally to cybersecurity and more specifically to systems and methods of using context-based countermeasures for cybersecurity threats.

### BACKGROUND

Cybersecurity, the practice of protecting systems and networks from digital attacks, is increasingly important in the digital age. Digital attacks are becoming increasingly sophisticated and conventional endpoint detection and response (EDR) solutions are losing their effectiveness. Many conventional EDR solutions are designed to detect and stop known attacks. However, there may be a significant delay (e.g., days, weeks, or months) between the time that a new attack is deployed and the time that the EDR solution is updated to detect and stop the attack. Moreover, malware has increasingly become polymorphic, meaning it continuously changes its pattern of behavior. This polymorphic nature further increases the response time of conventional EDR solutions.

### SUMMARY

A zero trust (ZT) system of the present disclosure protects a computer from unknown and unauthorized code. In order for code to run, it must first be loaded into memory. As an example, the ZT system has a trust agent (e.g., an OS-specific trust agent, also referred to as a ZT agent), which monitors processes performed during the runtime of a program and continuously validates the program's code. The validation procedure in this example is a background process that operates at the kernel level to identify processes that are performed during the runtime of a program. In implementations where the processes performed are reflected in real-time in the memory of the computer, the trust agent can identify processes as they are initiated or performed and deploy a series of countermeasures to check for suspicious or malicious code associated with the process. In implementations where the kernel does not receive information regarding processes that are performed in a program, the trust agent is able to deploy countermeasures in the form of checks at non-fixed time intervals (e.g., random checks) for suspicious or malicious code associated with the process. If suspicious or malicious code is identified, the trust agent sends an alert to a trust center. In some implementations, the trust agent also terminates the process associated with the suspicious or malicious code.

In accordance with some implementations, the ZT protection is implemented as a kernel agent (e.g., a kernel-level device driver). In this example, the kernel agent runs at Ring-0 on the protected device, whereas application code runs at Ring-3. In this example, while the agent is running it performs spot validation when code attempts to perform certain system level operations, such as file I/O operations, registry I/O operations, thread start and stop operations, and image load and unload operations. As discussed in greater detail later, countermeasures are employed to protect against a wide range of attacks. In this example, the countermeasures are selected and deployed based on an operating context of the computing device and/or based on the process running on the computing device. If one of the countermeasures detects an attack, then either the process is stopped and forensics captured, or the process is allowed to continue but with forensics being captured (e.g., based on a device policy).

In various circumstances, the ZT system of the present disclosure has the following advantages over conventional cybersecurity systems. First, in accordance with some implementations, the ZT system is effective against new and emerging threats as the system employs countermeasures designed to mitigate specific attacks. Second, in accordance with some implementations, because the ZT system monitors memory, it protects against attacks that start in memory via legitimate processes and applications. Third, the ZT system can operate on off-network (e.g., air gapped) systems as it can maintain and validate its trust store without requiring network access. Fourth, the ZT system can operate in parallel with other processes at the computing device, allowing a user's workflow to continue uninterrupted if an attack is not detected.

In accordance with some implementations, a method is performed at a computing device having memory and one or more processors. The method includes identifying a process running on the computing device and in response to identifying the process running on the computing device: (i) selecting one or more countermeasures from a plurality of countermeasures based at least in part on the determined process and (ii) executing each of the selected countermeasures at the computing device.

In accordance with some implementations, a method is performed at a computing device having memory and one or more processors. The method includes: (i) determining a first operating context for the computing device, (ii) identifying a first set of one or more countermeasures from a plurality of countermeasures based on the determined first operating context, and (iii) deploying the first set of one or more countermeasures at the computing device.

In some implementations, a computing device includes one or more processors, memory, a display, and one or more programs stored in the memory. The programs are configured for execution by the one or more processors. The one or more programs include instructions for performing any of the methods described herein.

In some implementations, a non-transitory computer-readable storage medium stores one or more programs configured for execution by a computing device having one or more processors, memory, and a display. The one or more programs include instructions for performing any of the methods described herein.

Thus, methods and systems are disclosed for deploying context-based countermeasures for cybersecurity. Such methods and systems may complement or replace conventional methods and systems of cybersecurity.

### BRIEF DESCRIPTION OF THE DRAWINGS

For a better understanding of the aforementioned systems, methods, and graphical user interfaces, as well as additional systems, methods, and graphical user interfaces that provide cybersecurity countermeasures, reference should be made to the Description of Implementations below, in conjunction with the following drawings in which like reference numerals refer to corresponding parts throughout the figures.

FIG. 1 illustrates an example network architecture in accordance with some implementations.

FIGS. 2A and 2B illustrate example deployment of countermeasures in accordance with some implementations.

FIG. 3 is a block diagram of an example computing device in accordance with some implementations.

FIG. 4 provides a flowchart of an example method for executing context-based countermeasures in accordance with some implementations.

FIG. 5 provides a flowchart of an example method for executing context-based countermeasures in accordance with some implementations.

Reference will now be made to implementations, examples of which are illustrated in the accompanying drawings. In the following description, numerous specific details are set forth in order to provide a thorough understanding of the present invention. However, it will be apparent to one of ordinary skill in the art that the present invention may be practiced without requiring these specific details.

### DESCRIPTION OF IMPLEMENTATIONS

In forensic analysis, identifying malware and determining where it originated can be a tedious and time-consuming task that often requires a large team of analysts to reverse compile, research, perform flow analysis, and compare to known patterns for attribution. Attribution is important because once the source is identified, then the attack may be better understood. The difference between an amateur actor and a nation-state attacker may be subtle and each may require different responses.

The present disclosure describes utilizing known good applications, extracting executable functions, and using the extracted executable functions as training data for an AI engine. The systems of the present disclosure may utilize known bad applications (e.g., malware and ransomware) to create similar patterns but identified as known bad. The systems may extract the corresponding executable functions and add to the training data, but tagged as “known bad”. Additionally, the meta information can be included. Once the training is completed, any unknown application can be scanned and checked, using the trained model, to determine if it is good or bad. The systems of the present disclosure may assign a confidence score to the unknown application (e.g., where a higher score may indicate a higher probability of being a good (non-malware application). Additionally, the systems of the present disclosure may identify which functions are bad and attribute the bad functions to a certain known piece (or pieces) of malware.

In some implementations, the system determines if functions have been copied (perhaps illegally) from other applications and/or determine the amount of GPL-based code used in an application.

The present disclosure also includes descriptions of trust systems, trust agents, and trust binaries. A zero trust (ZT) system as described herein identifies executables, extracts meta information, and tracks the information in a database. Since the trust agent detects unknown code in memory, the agent may pass the code segment to a ZT trust center for analysis for good, bad, or unknown.

A zero trust (ZT) system of the present disclosure protects a computer from unknown and unauthorized code. In order for code to run, it must first be loaded into memory. As an example, the ZT system has a trust agent (e.g., an OS-specific trust agent), which monitors each program as the program is loaded into memory and validates the program's code. The validation procedure in this example uses a trust binary, which is an alternate digital version of the original code. To execute code in this example, the ZT system requires a corresponding trust binary for the code. If the trust binary is missing or doesn't correlate, then the code is not allowed to execute on the system in this example.

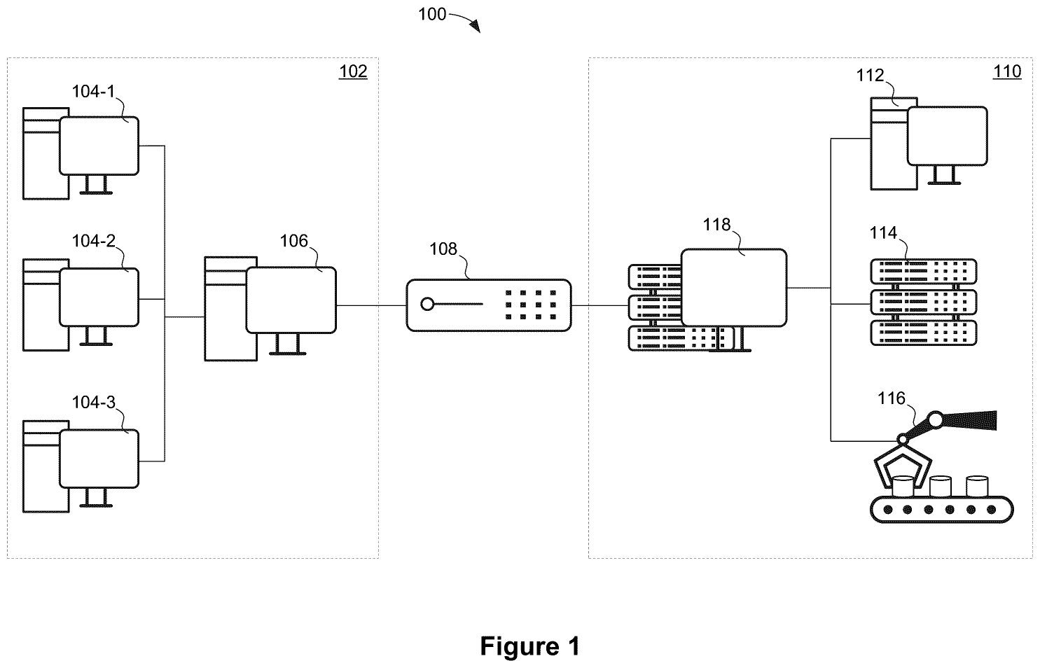

FIG. 1 illustrates a network architecture 100 in accordance with some implementations. The network architecture 100 includes an information technology (IT) portion 102 and an operational technology (OT) portion 110 communicatively coupled via a gateway device 108. The IT portion 102 includes user devices 104 (104-1, 104-2, and 104-3) and a hub device 106. In some implementations, each user device 104 includes a trust agent. In some implementations, the hub device 106 includes a trust store or trust center. In some implementations, the hub device 106 includes administrative software to manage countermeasures and/or countermeasure policies of the user devices 104. The OT portion 110 includes a supervisory terminal 118, a user terminal 112, a server 114, and equipment 116. In some implementations, the supervisory terminal 118, the user terminal 112, the server 114, and the equipment 116 each includes a trust agent. In some implementations, the supervisory terminal 118 includes software to manage countermeasures and/or countermeasure policies of the user terminal 112, the server 114, and the equipment 116. In some implementations, the gateway device 108 provides a demilitarized zone (DMZ) between the IT portion 102 and the OT portion 110. In some implementations, the gateway device 108 includes a trust center or trust store for the IT portion 102 and/or the OT portion 110. In some implementations, the gateway device 108 provides network access to an application store for the IT portion 102 and/or the OT portion 110. In some implementations, the network architecture 100 implements a Purdue Enterprise Reference Architecture (PERA) model. In reference to the PERA model, the IT portion 102 represents levels four and five, the gateway device 108 represents level three, and the OT portion 110 represents levels zero, one, and two.

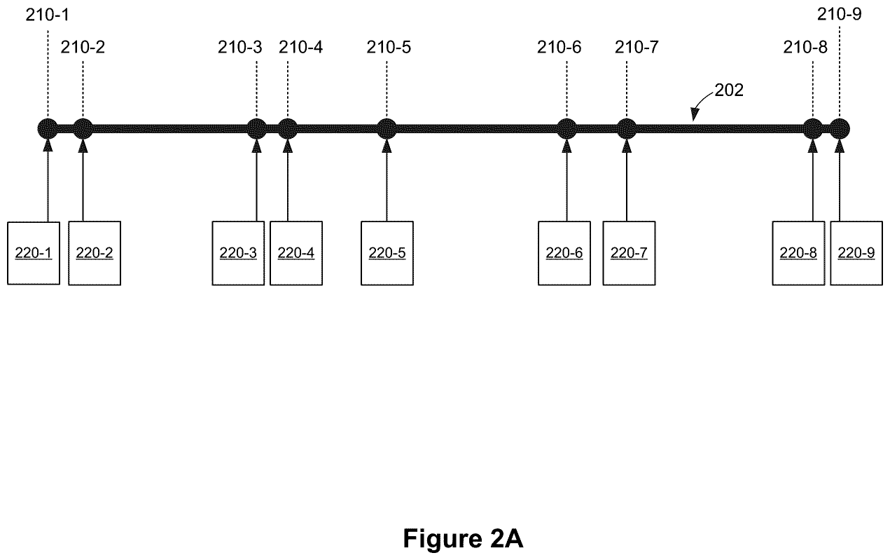

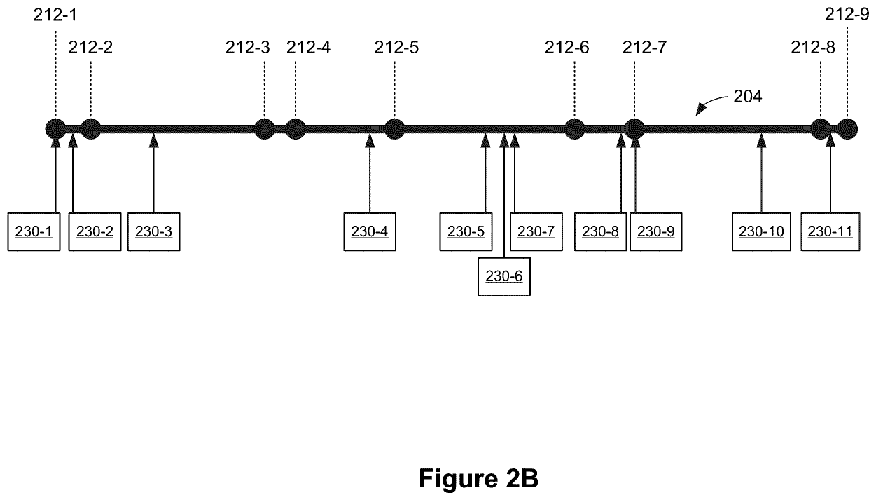

FIGS. 2A and 2B illustrate example deployment of a countermeasure process in accordance with some implementations.

In accordance with some implementations, trust binaries are used to protect all running code in memory on a protected device. For example, the ZT protection is implemented as a kernel agent (e.g., a kernel-level device driver). In this example, the kernel agent runs at Ring-0 on the protected device, whereas application code runs at Ring-3. An example ZT protection procedure includes loading the kernel agent, where the agent loads its trust binary from a trust database and verifies that the code in memory matches the trust binary (e.g., it has not been tampered with). In this example, while the agent is running it performs spot validation when code attempts to perform certain system level operations, such as file I/O operations, registry I/O operations, thread start and stop operations, and image load and unload operations. As discussed in greater detail below, additional countermeasures may also be employed to protect against a wide range of attacks. In this example, if the code doesn't match the trust binary or one of the countermeasures detects an attack, then either the process is stopped and forensics captured, or the process is allowed to continue but with forensics being captured (e.g., based on a device policy).

Many types of malware insert themselves at runtime into active processes on a computing device, such as a human-machine interface (HMI), a server, or a laptop. This allows the malware to go undetected and gain command and control of an active application on a device by elevating its privileges, pivot to (take control of) other applications, and do harm (e.g., ransomware) and/or perform other malicious activity such as data exfiltration, modification, or destruction.

The virtual memory used by an application may be examined to independently verify that each memory segment (e.g., series of consecutive pages) doesn't contain any form of malware or otherwise unknown programming. To develop an attack, the malware must somehow get into the application's memory. By examining the memory of each application (e.g., continuously and in real time), the malware may be detected as its being loaded into memory and stopped (e.g., at the earliest possible juncture).

The detected malware may be captured as forensic data and passed to a backend AI engine for further analysis or to continue to train a machine learning (ML) model (e.g., to continuously improve the efficacy of the detector).

A typical application at rest is a binary program consisting of machine instructions and other data used by the host operating system when loading the application into memory and initiating execution. The binary application in memory is sometimes referred to as a “process.” In some implementations, as part of loading the application into memory, the at-rest application has its digital signature checked to ensure it hasn't been tampered with at rest. The trust agent may also verify details about the application once loaded to ensure its integrity. For example, processes in a web conferencing application may include: entering a new meeting, video on/off, mute/unmute, share screen, send message via chat, record meeting, download recorded meeting, and end/leave meeting. In another example, processes in an email application may include: load new emails, read email, send email, add attachment, download attachment, view attachment, open link, and move email to a different folder. Each of these processes correspond to specific portions of code that are stored in memory and thus, different processes (and therefore different portions of code) may be more vulnerable to different types of malicious attacks.

A process may include the following memory segments: (i) read-only code, (ii) read-only data, (iii) read-write data, (iv) stack, and (v) dynamic memory. Modern computing hardware supports virtualized addressing and refers to chunks of memory as “pages.” The typical page size is 4096 bytes. Therefore the operating system allocates pages in physical memory and loads code and data into these pages, and maps them through the process page table. Each process may have its own page table, which describes each range of pages and its protection. For example, on the Windows operating system, pages are described through the VAD (Virtual Address Descriptor) table, which is a binary tree representing all pages allocated and used by a process. On the Linux operating system, there is a corresponding descriptor called Virtual Memory Areas. The techniques described below are the same regardless of the OS.

Each page may have “protection” in the form of the type of page, including: (i) read-only, (ii) execute-only, and (iii) read-write. Therefore, a well-behaved application will only have executable code in a collection of execute-only protected pages.

Since malware cannot modify existing execute-only pages, malware may allocate new pages that have read-write-execute protection, then insert itself into those pages, and either start a remote thread or use some other exploit to transfer control to the malware. The VAD table is not “exposed” from windows, so its structure has been reverse-engineered to detect suspect pages within a process and apply countermeasures. Each entry in the VAD table that has execute permission will typically be linked to an executable application or shared library. Other entries can be heap, stack, constant data, read/write data, and the like.

Having identified suspect VAD entries, there are several countermeasures that can leverage this technique. For example, for reflective injection where a shared library has been injected into an application, the first few bytes of a suspect VAD are checked to see if it has the identification for a binary image. If so, then a trustID is computed and checked. If the trustID isn't found or is on the blocklist, then the process is terminated and an alert is generated.

The countermeasures described herein are also applicable for shell code (e.g., small segments of code that are inserted into a process in order for malware to take control or run asynchronously) and heap spray, where heap spray is a repeating pattern of irrelevant machine instructions with a malicious payload at the end. This is generally seen in web browsers or any application that supports Javascript. For example, each VAD that is marked with execute permission and doesn't have a corresponding file is checked. Also, malicious Javascript can be detected by analyzing the text within the page for an encoded payload. Thus, the ZT countermeasures stop a process once a countermeasure has detected an anomaly and send an alert along with forensic data to a trust center.

The forensic data may include: (i) machine code (shellcode) extracted from memory, (ii) injected binaries extracted from memory, (iii) Javascript, (iv) compiled scripts (e.g., .NET and python), (vi) and/or heap spray patterns. The machine code and binaries may be broken down into basic blocks of execution and used to train an artificial intelligence (AI) model to look for known malicious code sequences. The Javascript may be used to train a Javascript-specific AI model to detect known malicious Javascript sequences. The compiled scripts may be used to train language-specific models to detect known malicious scripts. The heap spray patterns may be used to enhance the heap spray detector in a trust agent.

The AI countermeasure(s) may be available on the trust center for use by an endpoint (e.g., when it cannot identify a specific sequence of instructions or data). For example, the information is captured, sent to the trust center, and run through an AI engine for identification. If the corresponding process is determined to be malicious, the trust agent may be instructed to stop the process on the endpoint.

With ever evolving malware, ransomware, APT's, and the like, there is no single countermeasure that can detect and defeat all of them. An AI-based approach as described herein may employ different groups of countermeasures in specific contexts to determine if an application or segment of memory is malicious (e.g., is good or bad).

The AI machines include 4 types. The first type of AI machines are reactive machines that perform basic operations. This may be the simplest form of AI. This type takes in some input and reacts with some output. This type does not store any inputs and does not participate in learning. The second type of AI machines are limited memory machines that perform operations based on previously stored data or predictions and use that data to make better predictions. With limited memory, machine learning becomes a bit more complex as each machine learning model requires limited memory to be created, but the model can be deployed as a reactive machine. The third type of AI machines are theory of mind AI machines that interact with the thoughts and emotions of humans. The fourth type of AI machines are self-aware machines. In some implementations, a countermeasure is a reactive artificial intelligence machine. In some implementations, a countermeasure is a limited memory machine.

In some implementations, a countermeasure is trained based on a specific type of attack. For example, a first countermeasure may be trained using an attack that targets an application heap with a malicious payload, and a second countermeasure may be trained using an attack that raises an application's operating privileges during the application's execution. Different types of attacks have different signatures and can be detected using different methods and checks. Thus, by training each countermeasure for a specific type of attack, the trained countermeasure, when deployed, is capable of targeting and mitigating specific and distinct types of attacks. When multiple countermeasures are deployed (e.g., when countermeasures are deployed as a group or as a set), broad protection against many different types of attacks is provided.

As discussed above, for an attacker to break in and cause havoc, they need to get into memory and start to execute. The methods described herein may utilize filtering hooks available in most commercial operating systems when an application is loaded into memory and invoke a series of countermeasures to verify the trustworthiness of the application. Because there are so many attack points, different countermeasures may be used to broadly detect and prevent exploits. Each countermeasure may be trained to seek out a certain class of attack and, if detected, prevent the attack by stopping the host application, collecting forensic data, and/or reporting back to the trust center. Countermeasures are constantly being developed as new attacks are detected.

In some implementations, each countermeasure is an AI machine (e.g., either reactive or limited memory). The countermeasures are applied in different contexts to determine if an application can be trusted, or if an application has been attacked or tampered with. By applying countermeasures in groups, related attacks or attacks employing several different methods, can be more efficiently detected prior to assembly, or as the attack is being assembled, and stopped in-situ. Each countermeasure may be tuned to be efficient in resource consumption so that the host device will not be bogged down (slowed) by the countermeasure.

Countermeasure policy may be defined as one of three states. State (i)=“protect”: if a countermeasure finds an anomaly, it stops the process and reports the occurrence. State (ii)=“detect”: if the countermeasure finds an anomaly, it reports the occurrence and allows the process to continue. State (iii)=“off”: the countermeasure is disabled. Each countermeasure may have an exceptions list of process trustIDs that should not be processed by a specific countermeasure.

In some implementations, as shown in FIG. 2A, the trust agent deploys countermeasure(s) in response to execution of a process in an operating context (e.g., performing an action within a computer program or computer application, such as opening a new email in an email application or clicking on a link in a web browser). The trust agent, operating at the kernel level (e.g., at Ring-0) utilizes callbacks in the kernel to detect processes that are executed within a program or during a program runtime. By registering the trust agent for callbacks in the kernel, no changes are required at the kernel level, providing an efficient and seamless method of integrating the trust agent into processes running at the computing device. Deploying the countermeasure(s) includes using a device driver to reach memory in the computing device where code is stored, using a callback (e.g., triggered by a a file read request) to see which process(es) have been run, using a filter driver to identify the portions of the code that correspond to the identified process(es), and applying check(s) to the code in accordance with the countermeasure(s). In some implementations, the deployed countermeasure(s) are selected based at least in part on the identified processes (e.g., the executed action, such as loading an existing file or opening a new webpage). In some implementations, the deployed countermeasure(s) are selected based at least in part on the operating context (e.g., the program that the process is running in, such as a photo-editing application or a video game). For example, a set of countermeasure(s) may be deployed for a process to open a new application, and a different set of countermeasure(s) (e.g., differing by at least one countermeasure) may be deployed for a process to download a file. In another example, a set of countermeasure(s) may be deployed during the runtime of an online video game, and a different set of countermeasure(s) may be deployed during the runtime of a document sharing application.

FIG. 2A illustrates an example where a trust agent operating at the kernel level is able to monitor actions performed in a computer program running at a computing device. The trust agent is operating in the background of the computer operation and the trust agent launches countermeasure(s) in response to detecting execution of a process in the program. FIG. 2A illustrates a timeline 202 (shown as a thick solid line proceeding left to right) of a user's actions in a program during the runtime of the program. Each circle (e.g., solid dot) on the timeline 202 represents an executed or requested process 210. The processes 210 may include processes that are explicitly requested by a user (such as double clicking on an icon to open an application corresponding to the icon) as well as processes that are not explicitly requested by a user (e.g., automatically refreshing or updating content provided to a user in real time, such as loading new messages in a chat box while watching live streaming content). The trust agent is active (e.g., running) during operation of the computing device, including during the runtime (or operation) of the program corresponding to the timeline 202. Although the example shown in FIG. 2A illustrates nine processes 210 (i.e., the processes 210-1 through 210-9) throughout the runtime of the program associated with timeline 202, any number of processes may be performed during the runtime of a program.

Following this example, the timeline 202 for this program begins with a first process 210-1 to launch the application. In response to detecting the first process 210-1, the trust agent deploys first countermeasure(s) 220-1 for possible malicious attacks corresponding to the detected the process 210-1. For example, in response to detecting a ‘launch program’ process via a callback, the trust agent may launch one or more countermeasures to verify that the application is authorized (is trusted) to run on this computing device, such as launching a no trust countermeasure” (described below in further detail) and a “malicious script countermeasure” (described below in further detail). Processes 210-2 through 210-8 correspond to processes that may be performed during the runtime of the program. As shown, for each detected process, the trust agent deploys one or more countermeasures corresponding to the process. For example, in response to detecting the third process 210-3, a third set of one or more countermeasures 220-3 is deployed by the trust agent. Similarly, the trust agent deploys a fourth set of one or more countermeasures 220-4 when the fourth process 210-4 is detected. Since the countermeasures deployed are selected based on the detected process, in some implementations, the third set of countermeasure(s) 220-3 include different countermeasure(s) than the fourth set of countermeasure(s) 220-4. Alternatively, in some instances, the third set of countermeasure(s) 220-3 include the same countermeasure(s) as the fourth set of countermeasure(s) 220-4. The last process 210-9 shown in this example is a process to exit the program. Similarly to all other processes 210-1 through 210-8, the trust agent responds to detection of the last process 210-9 by deploying final countermeasure(s) 220-9. For example, the final countermeasure(s) 220-9 are selected to discover any ‘undetonated’ exploits that can be added as forensics for the trust agent.

In some implementations, the first set of countermeasure(s) 220-1 is different from the second set of countermeasure(s) 220-2 (e.g., differs by at least one countermeasure). In some implementations, the first set of countermeasure(s) 220-1 is different from and nonoverlapping with the second set of countermeasure(s) 220-2 (e.g., each countermeasure in the first set of countermeasure(s) 220-1 is different from and does not include any countermeasures in the second set of countermeasure(s) 220-2). In some implementations, the first set of countermeasure(s) 220-1 and the second set of countermeasure(s) 220-2 include at least one countermeasure in common with each other. In some implementations, the first set of countermeasure(s) 220-1 is the same as the second set of countermeasure(s) 220-2 (e.g., countermeasures in the first set of countermeasure(s) 220-1 are identical to the countermeasures in the second set of countermeasure(s) 220-2). In general, each set of countermeasures 220 (e.g., sets of countermeasures 220-1 through 220-9) may be identical to another set, have no overlap with another set, or partially overlap with another set.

In some implementations, as shown in FIG. 2B, the trust agent is unable to monitor (or detect) all actions performed in a computer program at the computing device and thus, the trust agent deploys countermeasures at non-fixed time intervals to try and intercept malicious attacks that may be executed during the runtime of the program. For example, some malicious attacks use “living-off-the-land” exploits, which are commonly created on the fly and may not trigger any of the kernel callbacks that would activate action from the trust agent. Thus, in some implementations, the trust agent deploys countermeasures at non-fixed time intervals to force all executed processes to be scanned (even if the process did not trigger a kernel callback). To deploy the countermeasure(s), the trust agent uses a device driver to reach memory in the computing device where code is stored, uses a callback to see which processes have been recently run (e.g., since the last deployment of countermeasures), uses a filter driver to identify the portions of the code that have been recently called corresponding to the recently executed processes, and applies check(s) to the code in accordance with the countermeasure(s). In some implementations, the deployed countermeasure(s) are selected based at least in part on the identified current operating context of the computing device (e.g., based at least in part on what program(s) are currently running on the computer). In some implementations, the trust agent deploys a set of pre-selected countermeasure(s). In some implementations, the set of countermeasure(s) are pre-selected based at least in part on what programs are currently running on the computer. In some implementations, the set of countermeasure(s) are pre-selected based at least in part on the operating system of the computer.

FIG. 2B illustrates an example where a trust agent operating at the kernel level is unable to monitor (or detect) all actions performed in a computer program at the computing device. In this case, the trust agent launches countermeasure(s) at various times (in some instances, at random times) during the application runtime. FIG. 2B illustrates a timeline 204 (shown as a thick solid line) of a user's actions in a program during a runtime of the program. Each circle (e.g., solid dot) on the timeline 204 represents an executed or requested process 212. The processes 212 are the same as the processes 210 in FIG. 2A, described above, with the exception that these processes 212 are not necessarily visible to the trust agent operating at the kernel of the computing device. Thus, details regarding the processes 212 that are already provided above with respect to the processes 210 in FIG. 2A are not repeated here for brevity. The trust agent is active (e.g., running) during operation of the computing device, including during the runtime (or operation) of the program corresponding to the timeline 204. In some implementations, the trust agent is operating in the background of the computer operation. Although the example shown in FIG. 2B illustrates nine processes (i.e., the processes 212-1 through 212-9) throughout the runtime of the program associated with timeline 204, any number of processes may be performed during the runtime of a program.

Following this example, the timeline 204 for this program includes multiple processes 212-1 through 212-9, starting with a first process 212-1 to launch the program and concluding with a final process 212-9 to exit or terminate the program. Since the trust agent is not necessarily able to visualize all of these processes 212-1 through 212-9, the trust agent sends a set of countermeasure(s) to look for suspicious or malicious activity at various times during the program runtime. For example, the trust agent may, at a first time, send a first set of countermeasure(s) 230-1 to check for and mitigate malicious attacks. The trust agent may, at a second time that is distinct from the first time, send a second set of countermeasure(s) 230-2 to check for and mitigate malicious attacks. Then, the trust agent may, at a third time that is distinct from each of the first time and the second time, send a third set of countermeasure(s) 230-3 to check for and mitigate malicious attacks.

In some implementations, the trust agent deploys sets of countermeasure(s) at non-fixed time intervals so that a time interval between the first time and the second time is different from the time interval between the second time and the third time (e.g., the amount of time elapsed between two instances where countermeasure(s) are deployed is variable). In some implementations, the trust agent deploys sets of countermeasure(s) at random time intervals.

Since the countermeasure(s) are deployed at non-fixed (in some cases, random) times, in some implementations, the trust agent deploys a set of countermeasure(s) at a time that happens to coincide with or at a time that occurs very shortly after a process 212 has been executed. In some implementations, a set of countermeasure(s) are deployed at times when no processes are executed. For example, FIG. 2B shows that sets of countermeasure(s) 230-1 and 230-9 occur at the same time as or very shortly after the processes 212-1 and 212-7 have occurred. However, the sets of countermeasure(s) 230-3, 230-4, 230-5, 230-6, 230-7, and 230-10 are deployed at times during which a process is not being executed.

In some implementations, the number of times that the trust agent deploys a set of countermeasure(s) 230 (e.g., 230-1, 230-2, . . . , or 230-11) is agnostic (e.g., not dependent on) the number of processes that are performed during the runtime of the program. In some implementations, the trust agent may deploy a set of countermeasure(s) 230 any number of times. In some implementations, the trust agent deploys a set of countermeasure(s) 230 a different number of times as there are processes performed during the runtime of the program. In some implementations, the trust agent deploys a set of countermeasure(s) 230 the same number of times as there are processes performed during the runtime of the program. For example, although FIG. 2B illustrates deployment of eleven sets of countermeasure(s) 230 (i.e., the sets of countermeasure(s) 230-1 through 230-11) throughout the runtime of the program associated with timeline 204, the trust agent may deploy a set of countermeasure(s) any number of times during the runtime of a program.

In some implementations, the first set of countermeasure(s) 230-1 is different from the second set of countermeasure(s) 230-2 (e.g., differs by at least one countermeasure). In some implementations, the first set of countermeasure(s) 230-1 is different from and nonoverlapping with the second set of countermeasure(s) 230-2 (e.g., each countermeasure in the first set of countermeasure(s) 230-1 is different from and does not include any countermeasures in the second set of countermeasure(s) 230-2). In some implementations, the first set of countermeasure(s) 230-1 and the second set of countermeasure(s) 230-2 include at least one countermeasure in common with each other. In some implementations, the first set of countermeasure(s) 230-1 is the same as the second set of countermeasure(s) 230-2 (e.g., the countermeasures in the first set of countermeasure(s) 230-1 is identical to the countermeasures in the second set of countermeasure(s) 230-2).

In some implementations, a countermeasure may be deployed in one of two modes: “detection mode” or “prevention mode.” The countermeasure, once deployed, initiates one or more checks in accordance with the countermeasure policy. In some implementations, such as when the one or more checks detects malicious or suspicious activity while the countermeasure is deployed in “detection mode”, the trust agent sends an alert to the trust center or the trust store. In some implementations, such as when the one or more checks detects malicious or suspicious activity while the countermeasure is deployed in “prevention mode”, the trust agent sends an alert to the trust center or the trust store and one or more actions are taken to prevent or mitigate the suspected attack. The one or more actions may include, for example, terminating a process and/or an application.

In some implementations, the one or more countermeasures are applied in a group. For example, in response to an identified process, the trust agent deploys multiple countermeasures to mitigate multiple types of attacks that are known to be associated with the identified process. For example, when the callback identifies a read process, a set of countermeasures directed toward the read buffer is deployed. In this case, the read buffer checks to see if data in the read buffer contains an executable file. If the buffer contains an executable file, the trust agent generates a TrustID for the binary in the read buffer corresponding to the executable file and launches a “no trust countermeasure” (described below in further detail). If the buffer does not contain an executable file, the trust agent launches one or more countermeasures directed towards checking the memory to see if anything malicious has been injected or created in the memory space (also referred to herein as “memory check countermeasures”. In another example, if the callback identifies that an image has been loaded, the trust agent will launch a “no trust countermeasure” as well as “memory check countermeasures.” In yet another example, some events trigger a full process scan. The trust agent launches “memory check countermeasures” to be run against each process in memory.

In some implementations, a countermeasure is executed in parallel to running the process (e.g., via the use of threading). In some implementations, the computing device can continue executing the process, uninterrupted, while the trust agent deploys the countermeasure. Thus, the trust agent can execute checks in accordance with the countermeasure policy, and even issue an alert to a trust center (or trust store) in the event that a suspicious agent is detected in response to the check. The computing device can continue executing the process without interruption or delay while the countermeasure is deployed. A process or program is only interrupted in the case where a suspicious agent is detected while the trust agent is in “prevention mode,” in which case the trust agent sends an alert to the trust center (or trust store) and terminates the process and/or the program.

In some implementations, the one or more countermeasures are received at the computing device via the trust agent before the process is detected. The trust center or trust store may include, for a respective process, a respective set of one or more countermeasures to be deployed in response to detecting the respective process. For example, the trust center or trust store may include a first set of one or more countermeasures to be deployed in response to detecting an ‘open file’ process, and a second set of one or more countermeasures to be deployed in response to detecting a ‘download image’ process. In some implementations, these countermeasures are received at the computing device, via the trust agent, prior to any process identification. In some implementations, these countermeasures are received at the computing device, via the trust agent, after an operating context (e.g., program) is identified and prior to identification of a process. In some implementations, these countermeasures are received at the computing device, via the trust agent, prior to identification of an operating context (e.g., program) and prior to identification of a process. In some implementations, the countermeasures are received at the computing device, via the trust agent, in response to (e.g., after) identifying the process running on the computing device.

In some implementations, the one or more countermeasures (e.g., any of the set of one or more countermeasures 220-1 through 220-9) are selected from a plurality of countermeasures that are stored at a trust center or a trust store. The plurality of countermeasures may include, for example, any of the following countermeasures:
A no-trust countermeasure may utilize a database of trusted and blocked application trustIDs as input to its reactive machine. For example, no-trust countermeasure may include a runtime check that happens when an application is first loaded into memory but before it starts running. This takes place prior to the operating system (OS) allowing the application to run. All addresses have been resolved and any shared objects loaded and symbols resolved. Address space layout randomization (ASLR) and data execution prevention (DEP) have been applied by the OS. This countermeasure may then suspend the application, calculate the trustID, and look up the trustID in the blocked table. If the trustID is not found, in the blocked table, the trust agent looks for the trustID in a trusted list. If the trustID is also not found in the trust list, the countermeasure handles according to policy. If the trustID is found in the trusted list, the countermeasure handles the process according to policy (e.g., resumes the application). The trust agent sends an alert to the trust center (or trust store) to report the anomaly or stop the application and report the anomaly. In some implementations, the no-trust countermeasure policy includes terminating the application.
A self-protection countermeasure (e.g., trust agent tamper countermeasure) ensures that the trust agent, services, and/or trust store are not tampered with on a local host. The self-protection countermeasure may include one or more of the following checks: (i) folders containing the ZT software only allow admin access, (ii) the trust store is only accessible using a trust utility program, (iii) the trust agent image has not been tampered, (iv) all services are running and responding, and (v) all registry entries have not been modified. Additionally, the self-protection countermeasure may include a check for an attack on the trust agent infrastructure, such as an attempt to remove the trust agent from an endpoint. If detected, the attempt is stopped. For example, an attempt to Read or Write to protected areas in storage corresponding to the trust agent, if are detected, are cancelled. Applications attempting to read these areas may be refused permission (e.g., any write access request is denied). If malicious intent to tamper with (e.g., attack) the trust agent is detected, an alert is sent to the trust center (or trust store).
A reflective injection countermeasure ensures unauthorized code is not loaded into a running application. This countermeasure may scan active application memory pages for a range of pages that has execute or read/write/execute permission and is not bound to a shared library. The countermeasure also includes checking the first few bytes of the first page to see if they represent an executable image or library. If the first few bytes of the first page are found to represent an executable image or library, the trust agent requests a trustID for the first page and checks for the trustID in the trust store (or trust center). If the trustID is not found, or the executable first page is on a blocklist, the trust agent sends an alert to the trust center (or trust store) and the application is handled according to policy. In some implementations, the reflective injection countermeasure policy includes terminating the loading process and/or terminating the application.
A heap spray countermeasure ensures the application heap has not been compromised with a malicious payload. A heap spray may consist of a series of unrelated instructions that have no other purpose but to take up space in the heap. A heap is used for dynamic storage within an application. The attack may write multiple copies of the attack, essentially “spraying” the no-op instructions along with the malicious payload, then use a buffer overrun error elsewhere in the application to enter the malicious payload. The heap spray countermeasure looks at the page permissions for read/write/execute, then looks for a repeating pattern of no-op instructions. If page permissions for read/write/execute and a repeating pattern of no-op instructions is detected, the trust agent sends an alert to the trust center (or trust store) and the application is handled according to policy. In some implementations, the heap spray countermeasure policy includes terminating the application.
A read buffer countermeasure ensures that if the application is reading a file, the first buffer being read is checked to see if it is an executable image. If the file includes an executable image, the trust agent requests a trustID for the executable image and checks for the trustID in the trust store (or trust center). If the trustID is not found, or the executable image is on a blocklist, then the read operation is terminated (e.g., canceled, prohibited, not executed, or not permitted) by the trust agent, the trust agent sends an alert to the trust center (or trust store) and the application is handled according to policy. In some implementations, the read buffer countermeasure policy includes terminating the application in addition to terminating the read process.
A write buffer countermeasure ensures that an untrusted application cannot be written to the hard drive of the device. When an application attempts to write to a file, the buffer to be written is checked to see if it contains an executable image. If the buffer includes an executable image, the trust agent requests a trustID for the executable image and checks for the trustID in the trust store (or trust center). If the trustID is not found, or the executable image is on a blocklist, then the write operation is terminated (e.g., prohibited, not executed, or not permitted) by the trust agent, the trust agent sends an alert to the trust center (or trust store) and the application is handled according to policy. In some implementations, the write buffer countermeasure policy includes terminating the application.
An unauthorized function countermeasure verifies that the current starting address of a thread within an application is in the known range of executable pages. If the current starting address cannot be verified by the trust agent, the trust agent sends an alert to the trust center (or trust store) and the process or the application is handled according to policy. In some implementations, the unauthorized function countermeasure policy includes terminating a process or an application associated with the unverified starting address.
A malicious script countermeasure performs checks on scripts in memory for a malicious payload. This may include searching for suspicious constructs within the script. If suspicious constructs are found within the script, then the trust agent sends an alert to the trust center (or trust store) and then the application is handled according to policy. In some implementations, the malicious script countermeasure policy includes terminating a process or an application associated with the identified malicious script.
A shell code countermeasure mitigates a shell code injection attack. This countermeasure may deterministically check for signs of malicious code (or suspicious code) at the start of shell code. If malicious code (or suspicious code) is detected at the start of the shell code, the trust agent sends an alert to the trust center (or trust store) and then the application is handled according to policy. In some implementations, the shell code countermeasure policy includes terminating the application in response to detecting malicious code (or suspicious code) at the start of the shell code.
A Javascript countermeasure detects Javascript in a buffer and deterministically checks for signs of suspicious behavior within the Javascript. If detected, the trust agent sends an alert to the trust center (or trust store) and then the application is handled according to policy. In some implementations, the Javascript countermeasure policy includes terminating the application in response to detecting suspicious Javascript in buffer.
A privilege escalation countermeasure checks if an application's operating privileges have been raised during its execution. If detected, the trust agent sends an alert to the trust center (or trust store) and then the application is handled according to policy. In some implementations, the privilege escalation countermeasure policy includes terminating the application in response to detecting that an application's operating privileges have been raised.
A tamper countermeasure checks to see if known code segments of an application have changed since it was initially loaded into memory. If detected, the trust agent sends an alert to the trust center (or trust store) and the application is handled according to policy. In some implementations, the tamper countermeasure policy includes terminating the application in response to detection of a change to known code segments.
A hollowing countermeasure checks to see if known code segments of an application have changed since it was initially loaded into memory and for whether the read only data segments changed or if page permission has changed from execute-only to read/write/execute. If any of the above changes are detected, the trust agent sends an alert to the trust center (or trust store) and the application is handled according to policy. In some implementations, the hollowing countermeasure policy includes terminating the application in response to detection of any of the changes listed above.
An immutable countermeasure protects folders and files from being improperly modified or removed. The countermeasure looks for attempts to change any file(s) or folder(s) that are originally designated as non-modifiable. If an attempt to modify these files or to modify its settings (to be modifiable) is detected, the application is handled according to policy.
A registry key countermeasure checks for whether invalid or hidden registry keys are being created or used. If detected, the registry operation is canceled, an alert is sent to the trust center (or trust store), and the application is handled according to policy. In some implementations, the registry key countermeasure policy includes terminating the application in response to the detection of the creation or usage of invalid or hidden registry keys.
A malicious path countermeasure checks to see if the path in storage of an application has been changed in order to exploit a bug on operating systems (e.g., Linux systems) to gain system privileges. If alteration of the path of an application is detected, the original application is terminated and an alert sent to the trust center (or trust store).
An image load countermeasure checks for an executable image that has been loaded into a process. The trust agent looks for a TrustID for the image (e.g., at a trust center or a trust store) and if a TrustID for the image is not found, the process is terminated and an alert is sent to the trust center (or trust store).
A malicious registry entry countermeasure checks for an improperly formed registry key name (e.g., in a Windows operating system). For example, a registry key may be used to store (e.g., hide) code for malware). If an improperly formed registry key name is detected, the trust agent prevents the Registry Key Name from being created and sends an alert to the trust center (or trust store).
A dynamic link library (DLL) hooking countermeasure checks to see if a DLL transfer address in the Import Address Table (e.g., an intermediate address table) has been changed to a memory address that is not in trusted memory. For example, a malicious DLL may be renamed to the same filename as a legitimate DLL. If the trust agent detects that the DLL transfer address in the Import Address Table has been changed to a memory address that is not in trusted memory, the trust agent will (if possible) restore the original address to its original value and an alert is sent to the trust center (or trust store).
A connection blocked countermeasure looks for an attempt to connect to an untrusted network address. For example, connection to an untrusted network address may allow a malicious attacker to infiltrate a computing device or computing system. If detected, the connection is refused (e.g., denied, rejected, or not permitted) and an alert is sent to the trust center (or trust store).
A digital certificate verification failed countermeasure looks for expired or otherwise invalid (e.g., not trusted) signing digital certificates or root certificate authority (CA) paths. If an invalid or expired signing digital certificate or CA path is detected, an alert is sent to the trust center (or trust store).

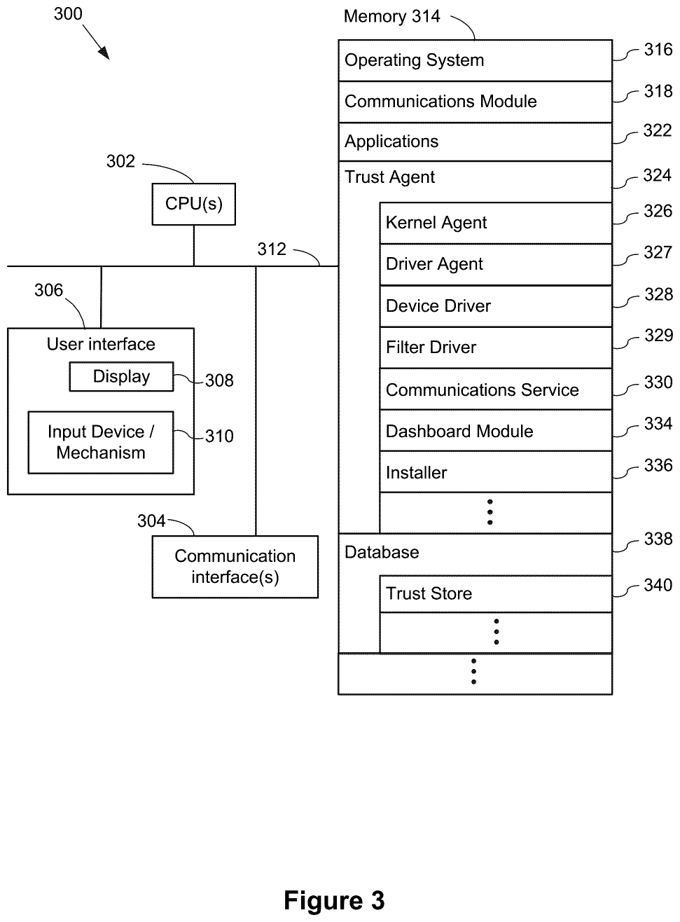

FIG. 3 is a block diagram of a computing device 300 in accordance with some implementations. Various examples of the computing device 300 include a desktop computer, a laptop computer, a tablet computer, and other computing devices (e.g., IT or OT devices) that have a processor capable of running a trust agent 324. The computing device 300 typically includes one or more processing units/cores (CPUs) 302 for executing modules, programs, and/or instructions stored in the memory 314 and thereby performing processing operations; one or more network or other communications interfaces 304; memory 314; and one or more communication buses 312 for interconnecting these components. The communication buses 312 may include circuitry that interconnects and controls communications between system components.

In some implementations, the computing device 300 includes a user interface 306 comprising a display device 308 and one or more input devices or mechanisms 310. In some implementations, the input device/mechanism includes a keyboard. In some implementations, the input device/mechanism includes a “soft” keyboard, which is displayed as needed on the display device 308, enabling a user to “press keys” that appear on the display 308. In some implementations, the display 308 and input device/mechanism 310 comprise a touch screen display (also called a touch sensitive display).

In some implementations, the memory 314 includes high-speed random-access memory, such as DRAM, SRAM, DDR RAM or other random-access solid-state memory devices. In some implementations, the memory 314 includes non-volatile memory, such as one or more magnetic disk storage devices, optical disk storage devices, flash memory devices, or other non-volatile solid state storage devices. In some implementations, the memory 314 includes one or more storage devices remotely located from the CPU(s) 302. The memory 314, or alternatively the non-volatile memory device(s) within the memory 314, comprises a non-transitory computer-readable storage medium. In some implementations, the memory 314, or the computer-readable storage medium of the memory 314, stores the following programs, modules, and data structures, or a subset thereof:
an operating system 316, which includes procedures for handling various basic system services and for performing hardware dependent tasks;
a communications module 318, which is used for connecting the computing device 300 to other computers and devices via the one or more communication network interfaces 304 (wired or wireless) and one or more communication networks, such as the Internet, other wide area networks, local area networks, metropolitan area networks, and so on;
applications 322 (e.g., running at Ring-3), which perform particular tasks or sets of tasks for a user (e.g., word processors, media players, web browsers, and communication platforms);
a trust agent 324, which protects the computing device 300 by validating executing code and monitoring system level operations, such as file I/O, registry I/O, thread start/stop, image loading/unloading, etc. The trust agent 324 includes one or more of:
   a kernel agent 326 (e.g., a kernel-level device driver that runs at Ring-0), which monitors applications in memory and deploys countermeasures and checks in accordance with countermeasure policies;
   a driver agent 327 (e.g., a kernel thread), which monitors active device drivers and applies countermeasures. In some implementations, the driver agent 327 verifies drivers and driver functions using trust binaries for the drivers and driver functions;
   one or more device drivers 328, which allow access to memory on the computing device;
   one or more filter drivers 329, which identify portions of memory associated with identified processes that have been executed at the computing device 300;
   a communications service 330 (e.g., a user-mode privileged process), which handles intra-communication of the trust agent 324 (e.g., between the kernel agent 326, the driver agent 327, and the dashboard module 334) and communication between the trust agent 324 and the trust store 340 and/or a trust center. In some implementations, the communications service 330 sends alerts and forensic data to a trust center and receives updates from the trust center. In some implementations, the communications service 330 checks for (e.g., requests) policy and/or software updates on a periodic basis (e.g., every 30 seconds, 30 minutes, or daily);
   a dashboard module 334, which provides a user interface for presenting alerts and allows for viewing/editing policy and/or trust binary information; and
   an installer 336, which identifies executable files, installs trust agent components, and requests trust binaries from trust center(s). In some implementations, the installer 336 is only obtainable from a trust center. In some implementations, the installer 336 is available for download from the trust center via a web browser. In some implementations, the installer 336 customizes installation of the trust agent components (e.g., based on device type, operating system, and administrator settings); and
one or more databases 338, which are used by the applications 322 and/or the trust agent 324. The one or more databases 338 including a trust store 340.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 314 stores a subset of the modules and data structures identified above (e.g., the trust agent 324 does not include the dashboard module 334). Furthermore, the memory 314 may store additional modules or data structures not described above (e.g., the trust agent 324 further includes a policy module).

Although FIG. 3 shows a computing device 300, FIG. 3 is intended more as a functional description of the various features that may be present rather than as a structural schematic of the implementations described herein. In practice, and as recognized by those of ordinary skill in the art, items shown separately could be combined and some items could be separated.

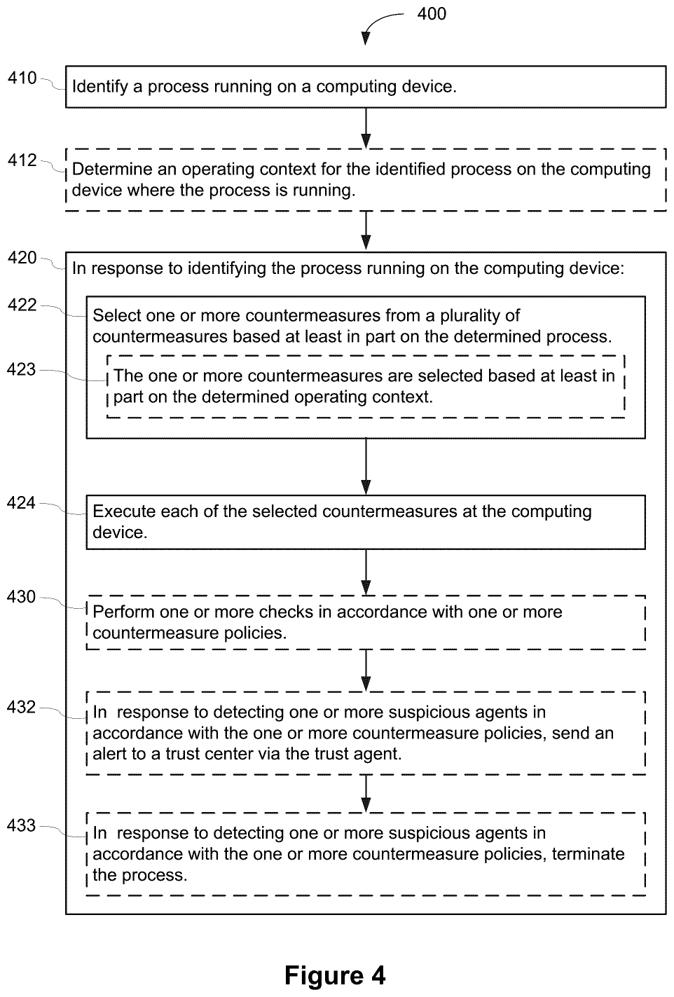

FIG. 4 provides a flowchart of an example method 400 for executing context-based countermeasures in accordance with some implementations. The method 400 includes identifying (step 410) a process 210 (e.g., any of the processes 210-1 to 210-9) running on a computing device 300. In some implementations, the method 400 further includes determining (step 412) an operating context (e.g., computer program or computer application, such as a program corresponding to timeline 202) for the identified process on the computing device 300 where the process 210 is running. In response to identifying (step 420) the process 210 running on the computing device 300, the device selects (step 422) one or more countermeasures from a plurality of countermeasures based at least in part on the determined process (e.g., selecting a set of one or more countermeasures 220-1 based at least in part on the process 210-1). In some implementations, the one or more countermeasures 220 are selected based at least in part on the determined operating context. The method further includes executing (step 424) each of the selected countermeasures at the computing device 300 (e.g., executing the set of one or more countermeasures 220-1).

The one or more countermeasures 220 are selected based at least in part on the determined operating context.

In some implementations, the method 400 further includes, in response to identifying (step 420) the process 210 running on the computing device 300: (i) performing (step 430) one or more checks in accordance with one or more countermeasure policies (e.g., policies associated with the one or more countermeasures 220), and (ii) in response to detecting one or more suspicious agents in accordance with the one or more countermeasure policies, sending (step 432) an alert to a trust center (or a trust store 340) via the trust agent 324.

In some implementations, the method 400 further includes, in response to identifying (step 420) the process 210 running on the computing device 300: in response to detecting one or more suspicious agents in accordance with the one or more countermeasure policies, terminating (step 433) the process 210.

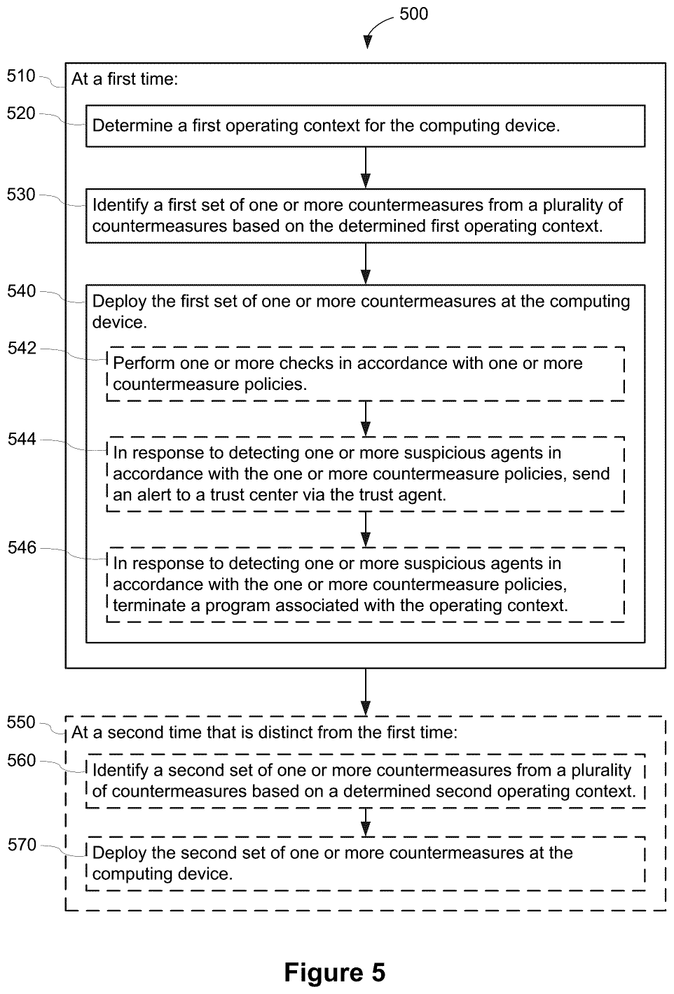

FIG. 5 provides a flowchart of an example method 500 for executing context-based countermeasures in accordance with some implementations. The method 500 includes, at a first time (step 510): determining (step 520) a first operating context (e.g., a program corresponding to timeline 204) for the computing device 300, identifying (step 530) a first set of one or more countermeasures 230-1 from a plurality of countermeasures based on the determined first operating context, and deploying (step 540) the first set of one or more countermeasures 230-1 at the computing device 300.

In some implementations, deploying (step 540) the first set of one or more countermeasures 230-1 at the computing device 300 includes: (i) performing (step 542) one or more checks in accordance with one or more countermeasure policies and (ii) in response to detecting one or more suspicious agents in accordance with the one or more countermeasure policies, sending (step 544) an alert to a trust center (or a trust store 340) via the trust agent 324.

In some implementations, deploying (step 540) the first set of one or more countermeasures 230-1 at the computing device 300 includes: (i) performing (step 542) one or more checks in accordance with one or more countermeasure policies and (ii) in response to detecting one or more suspicious agents in accordance with the one or more countermeasure policies, terminating (step 546) a program associated with the operating context.

In some implementations, the method 500 further includes, at a second time (step 550) that is distinct from the first time: identifying (step 560) a second set of one or more countermeasures 230-2 from a plurality of countermeasures based on a determined second operating context, and deploying (step 570) the second set of one or more countermeasures 230-2 at the computing device 300. In some implementations, the first operating context is the same as the second operating context (e.g., are the same program). In some implementations, the first operating context is different from the second operating context (e.g., the first program is a different program than the second program)

In accordance with some implementations, a method is performed at a computing device having memory and one or more processors. The method includes: (i) determining an operating context for a user device; (ii) identifying one or more countermeasures from a plurality of countermeasures based on the determined operating context; and (iii) deploying the one or more countermeasures to the user device. In some implementations, the plurality of countermeasures include one or more of: a no-trust countermeasure, a self-protection countermeasure, a reflective injection countermeasure, a heap spray countermeasure, a read buffer countermeasure, a write buffer countermeasure, an unauthorized function countermeasure, a malicious script countermeasure, a shell code countermeasure, a Javascript countermeasure, a privilege escalation countermeasure, a tamper countermeasure, a hollowing countermeasure, an immutable countermeasure, and a registry key countermeasure. In some implementations, the one or more countermeasures are deployed via a trust agent installed at the user device.

In some implementations, a computing device includes one or more processors, memory, a display, and one or more programs stored in the memory. The programs are configured for execution by the one or more processors. The one or more programs include instructions for performing any of the methods described herein.

In some implementations, a non-transitory computer-readable storage medium stores one or more programs configured for execution by a computing device having one or more processors, memory, and a display. The one or more programs include instructions for performing any of the methods described herein.

A zero trust (ZT) system of the present disclosure allows known good operating systems and application processes to execute in memory and prevents anything else from running. In accordance with some implementations, the zero trust system includes a trust agent installed at a computing device (also sometimes called an endpoint). The trust agent monitors and intercepts memory operations. The trust agent validates applications, processes, and functions before allowing them to run. Invalid applications, processes, and functions are blocked or monitored by the trust agent (e.g., depending on a security policy for the computing device). In some implementations, the ZT system utilizes a blockchain proof-of-identity scheme to validate its store of known good binaries and functions. In some implementations, the trust agent employs one or more of the countermeasures described previously.

The ZT system may compliment or replace conventional endpoint detection and response (EDR) solutions that handle known bad operating systems and application processes.

Turning now to some implementations.

(A1) A method is performed at a computing device having memory and one or more processors. The method includes: identifying a process running on the computing device and in response to identifying the process running on the computing device: (i) selecting one or more countermeasures from a plurality of countermeasures based at least in part on the determined process and (ii) executing each of the selected countermeasures at the computing device.

(A2) The method of A1, further including determining an operating context for the identified process on the computing device where the process is running. The one or more countermeasures are selected based at least in part on the determined operating context.

(A3) The method of A1 or A2, where the one or more countermeasures are received via a trust agent at the computing device prior to identifying the process

(A4) The method of any of A1-A3, where the one or more countermeasures are received via a trust agent at the computing device in response to identifying the process running on the computing device.

(A5) The method of any of A1-A4, where the one or more countermeasures are applied in a group.

(A6) The method of any of A1-A5, where at least one of the countermeasures of the selected countermeasures is executed in parallel to running the process.

(A7) The method of any of A1-A6, where a first countermeasure and a second countermeasure of the plurality of countermeasures are trained based on distinct types of malicious attacks.

(A8) The method of any of A1-A7, where a first countermeasure and a second countermeasure of the plurality of countermeasures are configured to mitigate distinct types of malicious attacks.

(A9) The method of any of A1-A8, further including, in response to identifying the process running on the computing device: (i) performing one or more checks in accordance with one or more countermeasure policies and (ii) in response to detecting one or more suspicious agents in accordance with the one or more countermeasure policies, sending an alert to a trust center via the trust agent.

(A10) The method of any of A1-A9, further including, in response to identifying the process running on the computing device: in response to detecting one or more suspicious agents in accordance with the one or more countermeasure policies, terminating the process.

(A11) The method of any of A1-A10, where one or more of the selected countermeasures are reactive artificial intelligence machines.

(A12) The method of any of A1-A11, where the one or more countermeasures include one or more of: a no-trust countermeasure, a self-protection countermeasure, a reflective injection countermeasure, a heap spray countermeasure, a read buffer countermeasure, a write buffer countermeasure, an unauthorized function countermeasure, a malicious script countermeasure, a shell code countermeasure, a Javascript countermeasure, a privilege escalation countermeasure, a tamper countermeasure, a hollowing countermeasure, an immutable countermeasure, a registry key countermeasure, a malicious path countermeasure, an image load countermeasure, a malicious registry entry countermeasure, a DLL hooking countermeasure, a connection block countermeasure, and a digital certificate verification countermeasure.

(B1) A method is performed at a computing device having memory and one or more processors. The method includes, at a first time: (i) determining a first operating context for the computing device; (ii) identifying a first set of one or more countermeasures from a plurality of countermeasures based on the determined first operating context; and (iii) deploying the first set of one or more countermeasures at the computing device.

(B2) The method of B1, further including, at a second time that is distinct from the first time: (i) identifying a second set of one or more countermeasures from the plurality of countermeasures based on a determined second operating context and (ii) deploying the second set of one or more countermeasures at the computing device.

(B3) The method of B1 or B2, where the first time and the second time are separated by a non-fixed time interval.

(B4) The method of any of B1-B3, where the first set of one or more countermeasures is received via a trust agent at the computing device.

(B5) The method of any of B1-B4, where a first countermeasure of the first set of one or more countermeasures is executed in parallel to running one or more processes at the computing device.

(B6) The method of any of B1-B5, where a first countermeasure and a second countermeasure are trained based on distinct types of malicious attacks.

(B7) The method of any of B1-B6, where a first countermeasure and a second countermeasure are configured to mitigate distinct types of malicious attacks.

(B8) The method of any of B1-B7, where deploying the first set of one or more countermeasures at the computing device includes: (i) performing one or more checks in accordance with one or more countermeasure policies and (ii) in response to detecting one or more suspicious agents in accordance with the one or more countermeasure policies, sending an alert to a trust center via the trust agent.

(B9) The method of any of B1-B8, where deploying the first set of one or more countermeasures at the computing device includes: in response to detecting one or more suspicious agents in accordance with the one or more countermeasure policies, terminating a program associated with the operating context.

(B10) The method of any of B1-B9, where the countermeasures in the plurality of countermeasures include one or more countermeasures that are reactive artificial intelligence machines.

(B11) The method of any of B1-B10, where the one or more countermeasures include one or more of: a no-trust countermeasure, a self-protection countermeasure, a reflective injection countermeasure, a heap spray countermeasure, a read buffer countermeasure, a write buffer countermeasure, an unauthorized function countermeasure, a malicious script countermeasure, a shell code countermeasure, a Javascript countermeasure, a privilege escalation countermeasure, a tamper countermeasure, a hollowing countermeasure, an immutable countermeasure, a registry key countermeasure, a malicious path countermeasure, an image load countermeasure, a malicious registry entry countermeasure, a DLL hooking countermeasure, a connection block countermeasure, and a digital certificate verification countermeasure.

Also note that methods (A1)-(A12) and (B1)-(B11) are not mutually exclusive. Some implementations follow the methodology of (A1)-(A12) when specific events or processes are detected, and deploy additional countermeasures as described by the methodology of (B1)-(B11) without a prompt by a specific event or process. Some implementations that combine the methodology of (A1)-(A12) with the methodology of (B1)-(B11) share one or more countermeasures. In addition, some implementations have one or more countermeasures that are deployed only in response to specific processes or events (e.g., as in (A1)-(A12)) or only when deploying countermeasures without a specific triggering event or process (e.g., as in B(1)-(B11)).

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

What is claimed is:

1. A method performed at a computing device having memory and one or more processors, the method comprising:
identifying a process running on the computing device;
in response to identifying the process running on the computing device:
selecting one or more countermeasures from a plurality of countermeasures based at least in part on the determined process; and
executing each of the selected countermeasures at the computing device.

2. The method of claim 1, further comprising:
determining an operating context for the identified process on the computing device where the process is running, wherein the one or more countermeasures are selected based at least in part on the determined operating context.

3. The method of claim 1, wherein the one or more countermeasures are received via a trust agent at the computing device prior to identifying the process.

4. The method of claim 1, wherein the one or more countermeasures are received via a trust agent at the computing device in response to identifying the process running on the computing device.

5. The method of claim 1, wherein the one or more countermeasures are applied as a group.

6. The method of claim 1, wherein at least one of the countermeasures of the selected countermeasures is executed in parallel to running the process.

7. The method of claim 1, wherein a first countermeasure and a second countermeasure of the plurality of countermeasures are trained based on distinct types of malicious attacks.

8. The method of claim 1, wherein a first countermeasure and a second countermeasure of the plurality of countermeasures are configured to mitigate distinct types of malicious attacks.

9. The method of claim 1, further comprising in response to identifying the process running on the computing device:
performing one or more checks in accordance with one or more countermeasure policies; and
in response to detecting one or more suspicious agents in accordance with the one or more countermeasure policies, sending an alert to a trust center via the trust agent.

10. The method of claim 1, further comprising in response to identifying the process running on the computing device:
in response to detecting one or more suspicious agents in accordance with the one or more countermeasure policies, terminating the process.

11. The method of claim 1, wherein one or more of the selected countermeasures are reactive artificial intelligence machines.

12. The method of claim 1, wherein the one or more countermeasures include one or more of:
a no-trust countermeasure, a self-protection countermeasure, a reflective injection countermeasure, a heap spray countermeasure, a read buffer countermeasure, a write buffer countermeasure, an unauthorized function countermeasure, a malicious script countermeasure, a shell code countermeasure, a Javascript countermeasure, a privilege escalation countermeasure, a tamper countermeasure, a hollowing countermeasure, an immutable countermeasure, a registry key countermeasure, a malicious path countermeasure, an image load countermeasure, a malicious registry entry countermeasure, a DLL hooking countermeasure, a connection block countermeasure, and a digital certificate verification countermeasure.

13. A computing device, comprising:
one or more processors;
memory;
a display; and
one or more programs stored in the memory and configured for execution by the one or more processors, the one or more programs comprising instructions for:
identifying a process running on the computing device; and
in response to identifying the process running on the computing device:
selecting one or more countermeasures from a plurality of countermeasures based at least in part on the determined process; and
executing each of the selected countermeasures at the computing device.

14. The computing device of claim 13, wherein the one or more programs further comprise instructions for:
determining an operating context for the identified process on the computing device where the process is running, wherein the one or more countermeasures are selected based at least in part on the determined operating context.

15. The computing device of claim 13, wherein the one or more countermeasures are received via a trust agent at the computing device in response to identifying the process running on the computing device.

16. The computing device of claim 13, wherein the one or more programs further comprise instructions for:
in response to identifying the process running on the computing device:
performing one or more checks in accordance with one or more countermeasure policies; and
in response to detecting one or more suspicious agents in accordance with the one or more countermeasure policies, sending an alert to a trust center via the trust agent.

17. A non-transitory computer-readable storage medium storing one or more programs configured for execution by a computing device having one or more processors, memory, and a display, the one or more programs comprising instructions for:
identifying a process running on the computing device; and
in response to identifying the process running on the computing device:
selecting one or more countermeasures from a plurality of countermeasures based at least in part on the determined process; and
executing each of the selected countermeasures at the computing device.

18. The non-transitory computer-readable storage medium of claim 17, wherein the one or more programs further comprise instructions for:
determining an operating context for the identified process on the computing device where the process is running, wherein the one or more countermeasures are selected based at least in part on the determined operating context.

19. The non-transitory computer-readable storage medium of claim 17, wherein the one or more countermeasures are received via a trust agent at the computing device in response to identifying the process running on the computing device.

20. The non-transitory computer-readable storage medium of claim 17, wherein the one or more programs further comprise instructions for:
in response to identifying the process running on the computing device:
performing one or more checks in accordance with one or more countermeasure policies; and
in response to detecting one or more suspicious agents in accordance with the one or more countermeasure policies, sending an alert to a trust center via the trust agent.
